(19) United States
(12) Patent Application Publication
(10) Pub. No.: US 2005/0082160 A1
(43) Pub. Date: Apr. 21, 2005

(54) Electro-kinetic air transporter and conditioner devices with a mesh collector electrode

(75) Inventor: Igor Y. Botvinnik, Novato, CA (US)

Correspondence Address: FLIESLER MEYER, LLP, FOUR EMBARCADERO CENTER, SUITE 400, SAN FRANCISCO, CA, 94111, US

(73) Assignee: Sharper Image Corporation, San Francisco, CA (US)

(21) Appl. No.: 10/687,069

(22) Filed: Oct. 15, 2003

(51) Int. Cl. B01J 19/08; B01J 19/12

(52) U.S. Cl. 204/164; 422/186.04

(57) ABSTRACT

Embodiments of the present invention are related to electro-kinetic air transporter-conditioner systems and methods. An electro-kinetic air conditioner device includes an inner hollow cylindrical mesh electrode having a first radius and an outer hollow cylindrical mesh electrode having a second radius that is larger than the first radius. The second hollow cylindrical mesh electrode surrounds the first hollow cylindrical mesh electrode. At least one emitter electrode is located within and generally parallel to the first hollow cylindrical electrode. A voltage source provides a high voltage potential difference between each emitter electrode and the inner hollow cylindrical mesh electrode. The outer hollow mesh electrode is preferably grounded, as well as insulated.

### CROSS REFERENCE TO RELATED APPLICATIONS

The present application is related to the following application and patent, each of which is incorporated herein by reference: U.S. patent application Ser. No. 60/500,437, filed Sep. 5,2003, entitled “Electro-Kinetic Air Transporter and Conditioner Devices with Insulated Driver Electrodes” and; U.S. Pat. No. 6,176,177, entitled “Electro-Kinetic Air Transporter Conditioner.”

### FIELD OF THE INVENTION

The present invention relates generally to devices that electro-kinetically transport and/or condition air.

### BACKGROUND OF THE INVENTION

It is known in the art to produce an airflow using electro-kinetic techniques, by which electrical power is converted into a flow of air without mechanically moving components. One such system was described in U.S. Pat. No. 4,789,801 to Lee (1988), depicted herein in simplified form as FIGS. 1A and 1B. System 100 includes a first array 110 of emitter electrodes 112 that are spaced-apart from a second array 120 of collector electrodes 122. The positive terminal of a high voltage pulse source 140 that outputs a train of high voltage pulses (e.g., 0 to perhaps +5 KV) is coupled to the first array 110, and the negative pulse source terminal is coupled to the second array 120 in this example.

The high voltage pulses ionize the air between arrays 110 and 120, and create an airflow 150 from the first array 110 toward the second array 120, without requiring any moving parts. Particulate matter 160 in the air is entrained within the airflow 150 and also moves towards the collector electrodes 122. Some of the particulate matter is electrostatically attracted to the surfaces of the collector electrodes 122, where it remains, thus conditioning the flow of air exiting system 100. Further, the high voltage field present between the electrode arrays can release ozone into the ambient environment, which can eliminate odors that are entrained in the airflow.

In a further embodiment of Lee shown herein as FIG. 2, a third array 230 includes passive collector electrodes 232 that are positioned midway between each pair of collector electrodes 122. According to Lee, these passive collector electrodes 232, which were described as being grounded, increase precipitation efficiency. However, because the grounded passive collector electrodes 232 (also referred to hereafter as driver electrodes) are located close to adjacent negatively charged collector electrodes 122, arcing (also known as breakdown or sparking) may occur between collector electrodes 122 and driver electrodes 232 if the potential difference therebetween is too high, or if a carbon path is produced between an electrode 122 and an electrode 232 (e.g., due to a moth or other insect that got stuck between an electrode 122 and electrode 232). It is also noted that driver electrodes are sometimes referred to as interstitial electrodes because they are situated between other (i.e., collector) electrodes.

Increasing the voltage difference between the emitter electrodes 112 and the collector electrodes 122 is one way to further increase particle collecting efficiency and air flow rate. However, the extent that the voltage difference can be increased is limited because arcing may eventually occur between the collector electrodes 122 and the driver electrodes 232. Such arcing will typically decrease the collecting efficiency of the system, as well as produce an unpleasant odor.

In each of the above systems, the general arrangement is to include emitter electrodes upstream from a plurality of plate like collector electrodes. This arrangement may somewhat limit the type of form factor that can be produced. There is a desire to provide other types of form factors that provide good collecting efficiency, and can be used to produce systems that are more compact. It would also be beneficial if alternative form factors were relatively easy and inexpensive to produce.

### SUMMARY OF THE PRESENT INVENTION

Embodiments of the present invention are related to electro-kinetic air transporter-conditioner systems and methods.

In accordance with embodiments of the present invention, an electro-kinetic air conditioner device includes an inner hollow cylindrical mesh collector electrode having a first radius and an outer hollow cylindrical mesh electrode having a second radius that is larger than the first radius. The outer hollow cylindrical mesh electrode surrounds the inner hollow cylindrical mesh electrode. At least one emitter electrode is located within and generally parallel to the inner hollow cylindrical mesh electrode. A voltage source provides a high voltage potential difference between each emitter electrode and the inner hollow cylindrical mesh electrode. A flow of air including ions and charged particles is produced from each emitter electrode toward a closest mesh wall of the hollow mesh collector electrode. At least a portion of the charged particles are attracted to and collect on the hollow mesh collector electrode, thereby cleaning the air. In accordance with an embodiment of the present invention, the collector electrode is removable from a housing so that it can be cleaned (e.g., by running it under water or putting it in a dishwasher, etc.).

In accordance with embodiments of the present invention, the outer hollow cylindrical mesh electrode and each emitter electrode is grounded, and the voltage source provides a high negative voltage to the inner hollow cylindrical electrode. Other voltage arrangements are also possible.

In accordance with an embodiment of the present invention, each emitter electrode is located closer to a circumference of the inner hollow cylindrical mesh electrode than to a radial center of the inner hollow cylindrical mesh electrode.

In accordance with embodiments of the present invention, the outer hollow mesh electrode includes an electrically conductive mesh covered by an insulating dielectric material. The dielectric material can be coated with an ozone reducing catalyst, to thereby reduce ozone that is produced in the ionization region surrounding each emitter electrode.

In accordance with embodiments of the present invention, each emitter electrode is wire-shaped, but can alternatively be saw-tooth shaped, be made of a column of needles or tapered electrodes, etc.

In accordance with embodiments of the present invention, the hollow mesh electrodes have shapes other than that of a cylinder. For example, the hollow mesh electrodes can be square, rectangular, oval, etc.

Other features and advantages of the invention will appear from the following description in which the preferred embodiments have been set forth in detail, in conjunction with the accompanying drawings and claims.

### BRIEF DESCRIPTION OF THE FIGURES

FIG. 1A illustrates schematically, a prior art electro-kinetic air conditioner system.

FIG. 1B illustrates a perspective view of the electrodes shown in FIG. 1A.

FIG. 2 illustrates schematically, a further prior art electro-kinetic air conditioner system.

FIG. 3A illustrates a perspective view of an electro-kinetic air conditioner system according to an embodiment of the present invention.

FIG. 3B illustrates a simplified perspective view of the system of FIG. 3A.

FIG. 3C illustrates a simplified top view of the system of FIGS. 3A and 3B.

FIGS. 3D-3F show simplified perspective views of alternative embodiments of the present invention.

FIG. 4 is block diagram showing an exemplary implementation of a high voltage source that can be used with embodiments of the present invention.

FIG. 5 is a perspective view of a housed electro-kinetic air conditioner system according to an embodiment of the present invention.

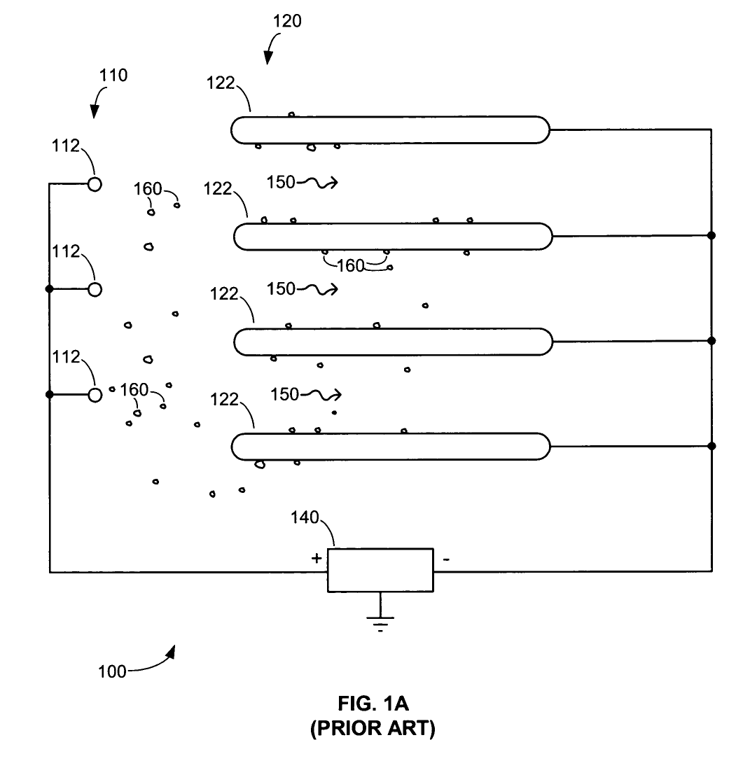

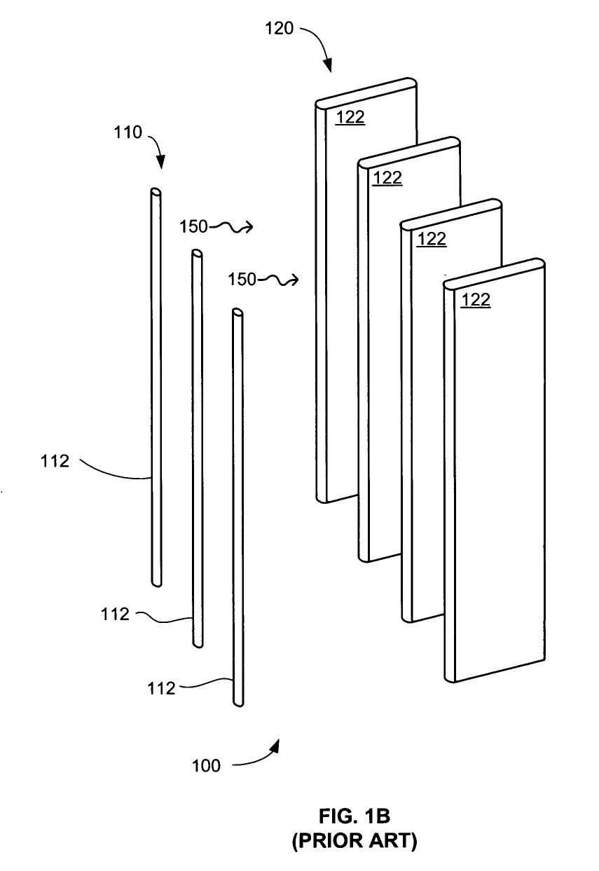

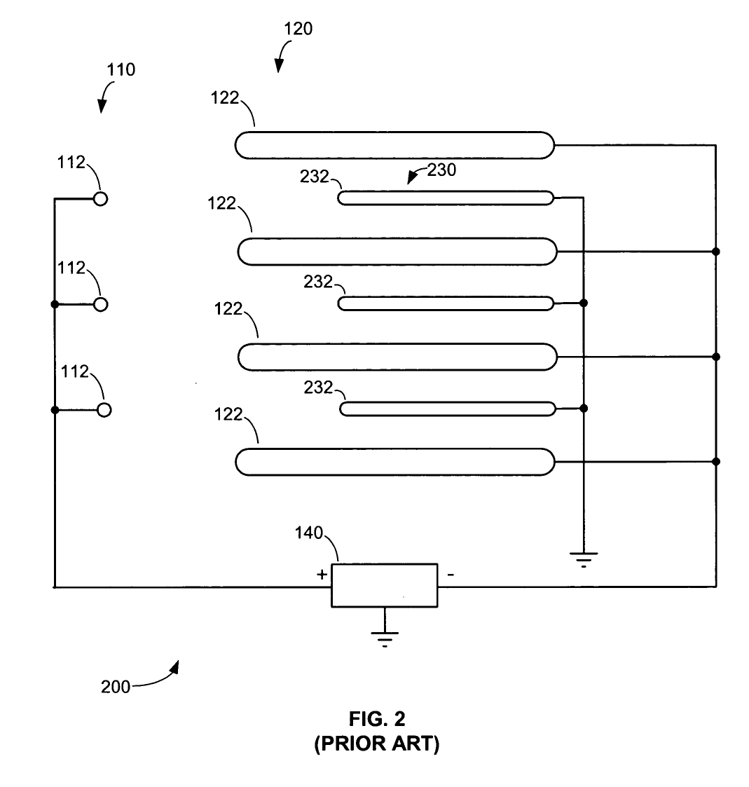

### DETAILED DESCRIPTION

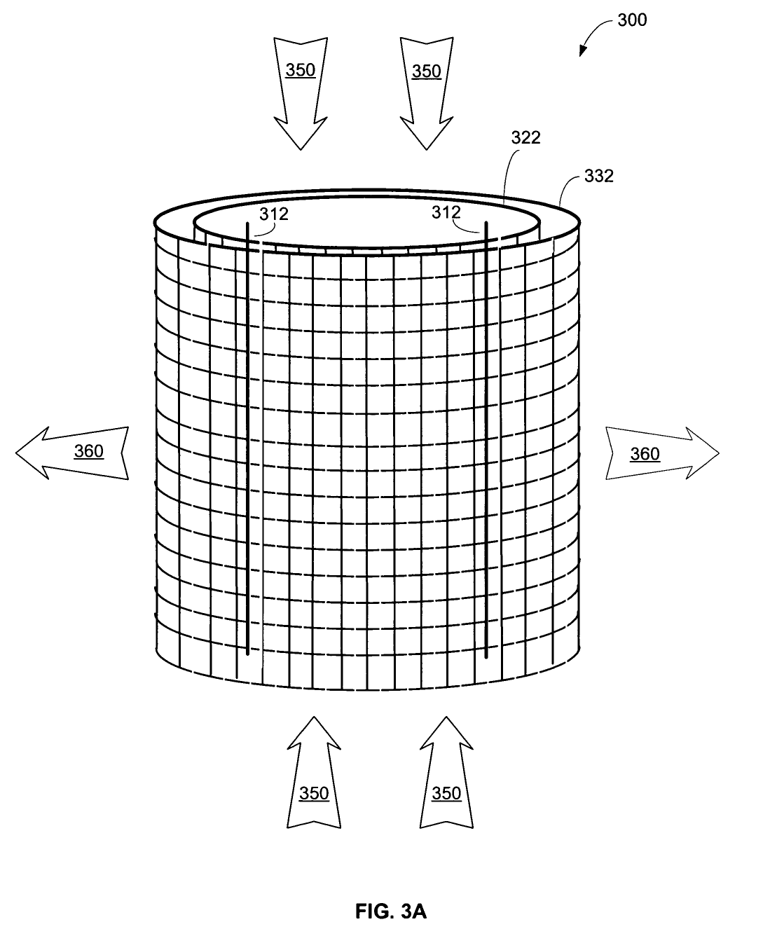

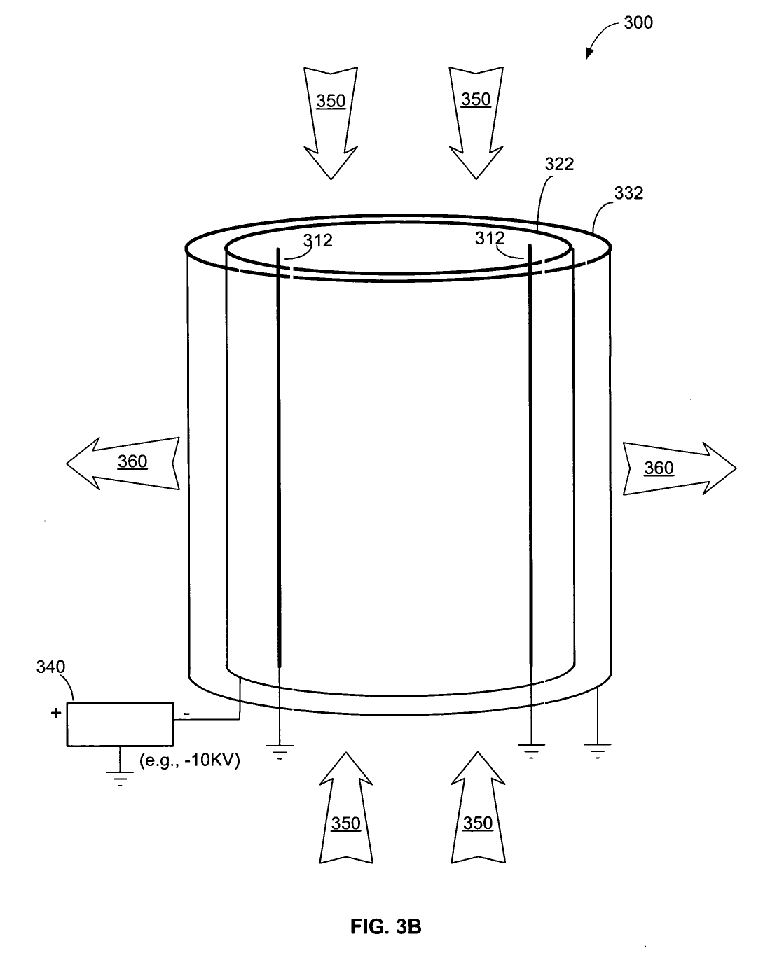

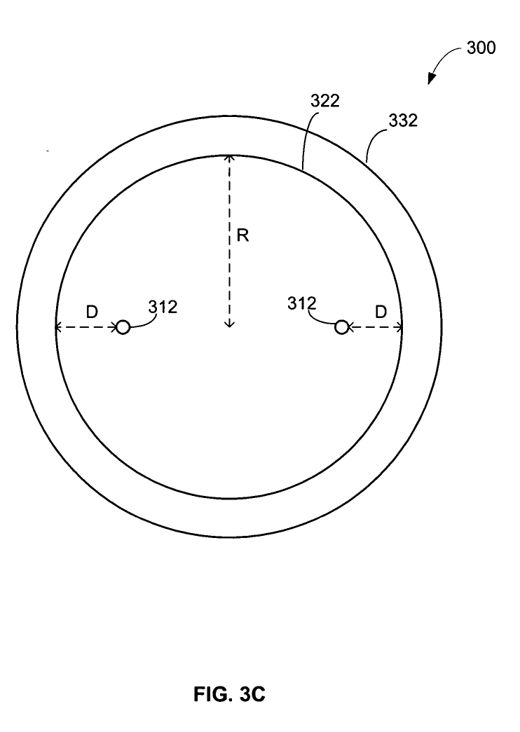

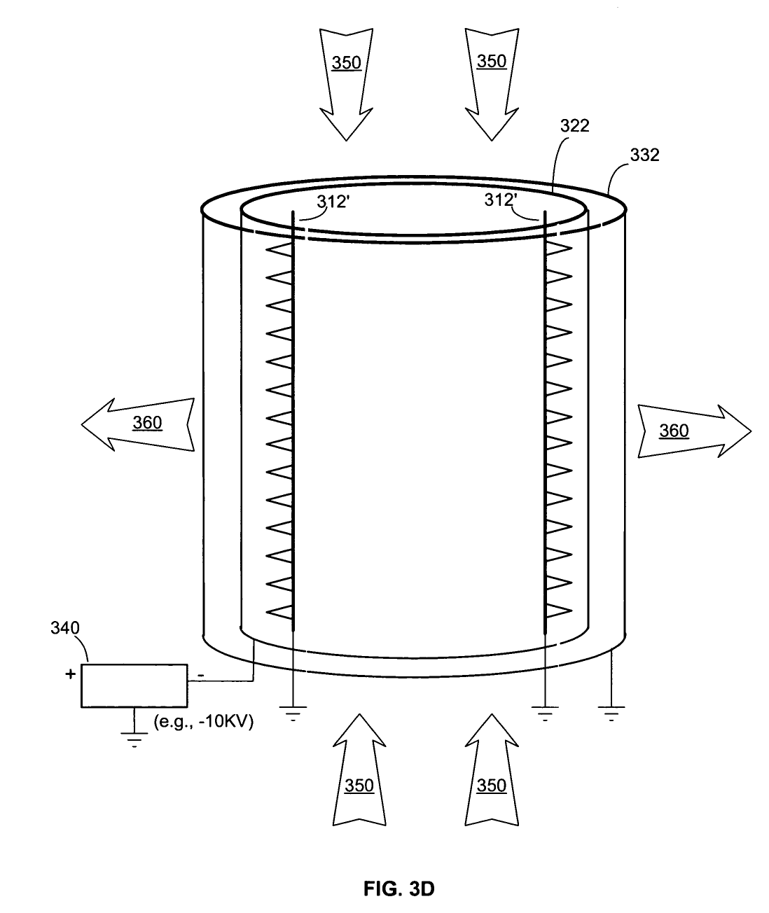

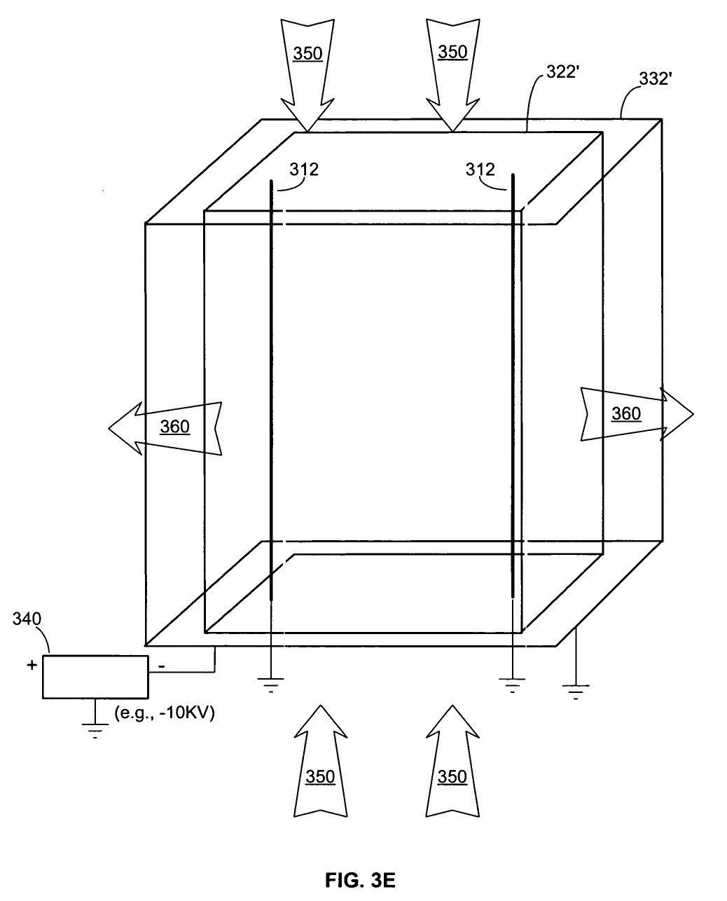

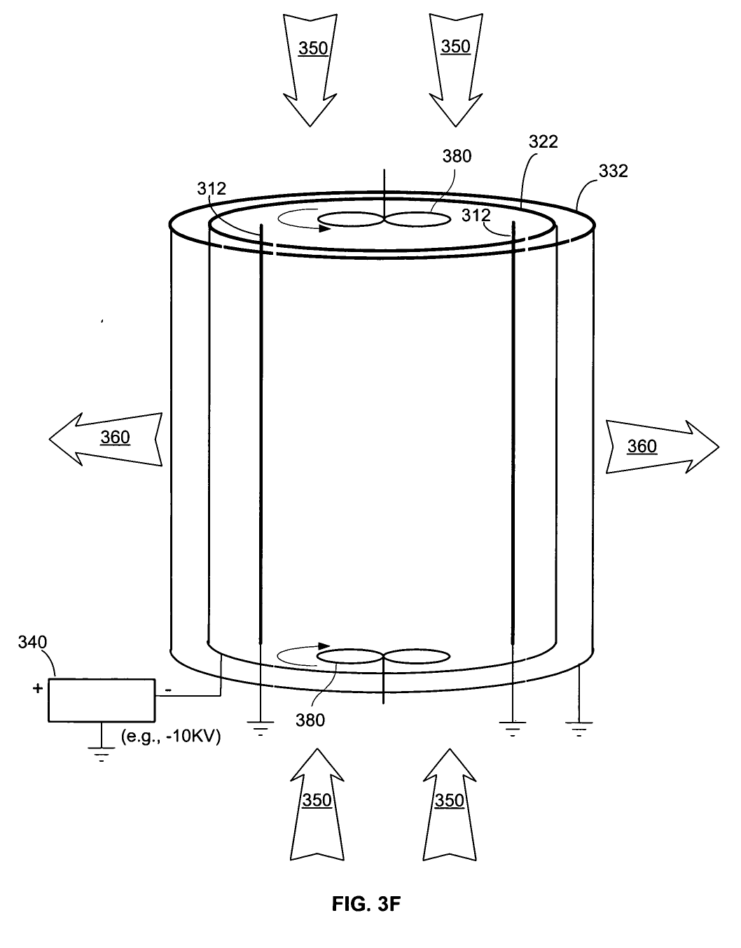

FIG. 3A illustrates a perspective view of an electro-kinetic conditioner system 300, according to an embodiment of the present invention. The system 300 is shown as including a pair of emitter electrode(s) 312, surrounded by a cylindrical mesh collector electrode 322. In accordance with an embodiment of the present invention, an outer cylindrical mesh electrode 332 surrounds the cylindrical mesh collector electrode 322.

FIG. 3B only shows the outlines of the cylindrical electrodes 322 and 332, and thus provides a simplified perspective view of the system 300 shown in FIG. 3A. In this embodiment, the emitter electrode(s) 312 are shown as being grounded, while the cylindrical mesh collector electrode 322 is shown as being connected to a negative terminal of a high voltage source 340. The outer cylindrical mesh electrode 332 is also shown to be grounded. FIG. 3C shows a top view of the embodiment of FIGS. 3A and 3B.

In accordance with an embodiment of the present invention, the outer cylindrical mesh electrode 332 is insulated with a dielectric material. The dielectric material can be, for example, an insulating varnish, lacquer or resin. The dielectric material can be sprayed or otherwise deposited onto the outer mesh electrode 332. Alternatively, the outer mesh electrode 332 can be dipped into a vat of dielectric material. After being applied to the surface of the outer mesh electrode 332, the dielectric material dries and forms an insulating coat or film a few mils in thickness covering the electrode 332. The dielectric strength of the insulation can be, for example, above 1000 V/mil (Volts per one-thousands of an inch). Such insulating varnishes, lacquers and resins are commercially available from various sources, such as from John C. Dolph Company of Monmouth Junction, N.J., and Ranbar Electrical Materials Inc. of Manor, Pa. These are just a few examples of dielectric materials that can be used to insulate the outer mesh electrode 332. Other types of insulating materials include porcelain enamel or fiberglass. It is within the spirit and scope of the present invention that other insulating dielectric materials can be used to insulate the outer mesh electrode 332. It is also within the spirit and scope of the present invention that an insulating dielectric material can be applied in other manners.

During operation of system 300, the high voltage source 340 negatively charges the mesh collector electrode 322. For example, the voltage on the collector electrode 322 can be −16KV, resulting in a 16KV potential difference between the grounded emitter electrodes 312 and the mesh collector electrode 322. This potential difference will produces a high intensity electric field that is highly concentrated around the emitter electrodes 312. More specifically, a corona discharge takes place from the emitter electrodes 312 to adjacent portions of the mesh collector electrode 322, producing ions that are positively charged. This causes particles (e.g., dust particles) in the vicinity of the emitter electrodes 312 become positively charged relative to the mesh collector electrode 322. The positively charged particles are attracted to and deposited on the negatively charged collector electrode 322.

Additionally, there will be a further electrical field produced by the 16KV potential difference between the grounded insulated outer mesh electrode 332 and the mesh collector electrode 322. This further electric field will cause some of the particles, which manage to escape through the mesh collector electrode 322 without sticking to the collector electrode 322, to be pushed back toward the collector electrode 322. This should reduce the amount of particles that will not be collected. Stated another way, this should increase collection efficiency.

If the outer mesh electrode 332 were not insulated, then the outer mesh electrode 332 would have to spaced a sufficient distance from the mesh collector electrode 322 such that sparking would not occur between the grounded outer mesh electrode 332 and the highly charged mesh collector electrode 322. By insulating the outer mesh electrode 332, the outer electrode 322 can be placed very close to the highly charged mesh collector electrode 322, without undesirable sparking occurring. Further, by grounding the insulated outer mesh electrode 332, safety is increased. More specifically, a person can safely touch the grounded insulated outer mesh electrode 332 without the potential of a spark jumping from the highly charged mesh collector electrode 322 to the person, if the outer mesh electrode 332 is grounded.

If system 300 did not include a grounded insulated outer mesh electrode 332, then for safety reasons there would need to be some type of vented plastic housing that surrounds the highly charged collector electrode 332. The distance between the vented housing and the highly charge mesh collector electrode would need to be sufficient so that a spark would not jump from the mesh collector electrode 332 to a person's hand, if a person was to put there hand near the housing. Accordingly, the use of a grounded insulated outer mesh electrode 332 enables the overall size of system 300 to be kept compact, as well as increases safety.

Further, if the outer mesh electrode 332 were not insulated, then the extent that the voltage difference (and thus, the electric field) between the mesh collector electrode 322 and the outer mesh electrode 332 could be increased would be limited because arcing would occur between the collector electrodes and an un-insulated outer mesh collector beyond a certain voltage potential difference. However, with the present invention, the insulation covering outer mesh electrode 332 significantly increases the voltage potential difference that can be obtained between the mesh collector electrode 322 and the outer mesh electrode 332 without arcing. The increased potential difference results in an increase electric field, which significantly increases particle collecting efficiency.

As will be described in further detail below, a system such as system 300 will likely be included within or as part of a freestanding housing the is meant to be placed in a room (e.g., near a corner of a room) to thereby clean the air in the room, circulate the air in the room, and increase the concentration of negative ions in the room.

As can be appreciated from the FIGS. 3B and 3C, each emitter electrode 312 is shown as being generally parallel with the walls of the mesh collector electrode 322. Additionally, each emitter electrode 312 is shown as being offset from a radial center 370 of the cylindrical mesh electrode 332 (as opposed to at the radial center 370). As can be appreciated from FIG. 3C, in accordance with an embodiment of the present invention, each emitter electrode 312 is a distance D from the cylindrical mesh electrode 322, wherein the distance D is less than one-half of the radius R of the cylindrical mesh electrode 322. More generally, the emitter electrodes 312 should be placed close enough to the mesh collector electrode 322 such that a high intensity electric field will be highly concentrated around the emitter electrodes 312, but without arcing occurring between the emitter electrodes 312 and mesh collector electrode 322.

The collector electrode 322 is made from a mesh material so that air can easily flow through openings in the mesh, with particle being collected on physical portion of the mesh. The insulated outer mesh electrode should also allow air to easily flow through the mesh. The mesh electrodes 322 and 332 can have any number of different mesh patterns. For example, the mesh pattern can resemble a pattern of multiple squares, rectangles, hexagons, octagons, circles, etc.

Preferably, the mesh is made of wire like strands that are woven into a mesh. Alternatively, the mesh can be a sheet metal material that includes numerous openings (e.g., perforations) therethrough. These are just a few examples, which are not meant to be limiting. What is important is that air can flow through the material from which the hollow electrodes 322 and 332 are made.

Each emitter electrode 312 can be fabricated, for example, from tungsten. Tungsten is sufficiently robust in order to withstand cleaning, has a high melting point to retard breakdown due to ionization, and has a rough exterior surface that seems to promote efficient ionization. The emitter electrodes 312 are likely wire-shaped, and are likely manufactured from a wire or, if thicker than a typical wire, still has the general appearance of a wire or rod. A column of points can be used in place of a wire. For example, an elongated saw-toothed edged electrode 312′ can be used, as shown in FIG. 3D, with each edge or point functioning as a corona discharge point. A column of tapered pins or needles would function similarly. Other types and configurations of emitter electrodes can be used and are within the spirit and scope of the present invention, such as those disclosed in U.S. patent application Ser. No. 10/074,082, filed Feb. 12, 2002, entitled “Electro-Kinetic Air Transporter-Conditioner Devices with Upstream Focus Electrodes,” which is incorporated herein by reference.

These are just a few examples of the emitter electrodes 312 that can be used with embodiments of the present invention. Further, other materials besides tungsten can be used to produce the emitter electrodes 312. In each of these embodiments it is preferable that each emitter electrode be generally parallel with the mesh collector electrode 322 so that the electric field between each emitter and collector is generally uniform along the length of the electrodes. However, embodiments would still function without the emitter(s) 312 being parallel to the collector 322.

As shown in FIGS. 3A and 3B, assuming the top and bottom portions of system 300 are not obstructed, air will enter through the top and bottom portions of the cylindrical system 300 (as shown by arrows 350) as well as through the side walls of the system. The electric field between each emitter electrode 312 and the mesh collector electrode 322 will cause the air to flow out through the mesh collector electrode 322 and the mesh outer electrode 332 in a generally radial direction, as shown by arrows 360. As can be seen from FIGS. 3A and 3B, each emitter electrode will produce a stream of air.

Although FIGS. 3A and 3C show two emitter electrode(s) 312, other numbers of emitter electrodes 312 can be included. There can be as few as a single emitter electrode 312. However, this will cause air to flow in only one generally radial direction (which may be desired). There may also be more than two emitter electrodes 312. Where there are multiple emitter electrodes 312, they can be evenly (i.e., equiangularly) spaced about the circumference of the mesh collector electrode 322 to produce generally uniform flow of air in various radial directions, although this is not required. Alternatively, the emitter electrodes 312 can be unevenly (i.e., non-equiangularly) spaced about the circumference if a directed flow or discharge pattern is desired. Emitter electrodes 312 should be far enough from one another so that the corona region about each emitter is not adversely effected by adjacent emitters. Further, the total number of emitters should not be such that the collection of emitters will act as an internal cylinder, rather than as multiple independent emitting electrodes.

The use of cylindrical electrodes 322 and 332 is beneficial for a number of reasons. First, a cylinder is very easy and inexpensive to manufacture and mass produce from a sheet of mesh material. For example, two opposing ends of a rectangular sheet of mesh material can be rolled toward one another and connected together to form a cylinder. Additionally, the cylindrical shape is such that it is lightweight, strong and self supporting, even if the mesh walls are not very thick. Further, a cylindrical shape is more space efficient than other shapes that include corners. Despite the benefits that are achieved by making the mesh collector electrode 322 and outer mesh electrode 332 cylindrical, these electrodes can have other shapes while still being within the spirit and scope of the present invention. For example, electrodes 322 and 332 can alternatively have a hollow square, rectangular or oval shape, as well as other shapes. FIG. 3E show an exemplary embodiment with a rectangular mesh collector electrode 322′ and a rectangular mesh outer electrode 332′.

In the system 300 just described, the emitter electrodes 312 are grounded, the mesh collector electrode 322 is charged with a high negative voltage, and the outer mesh electrode 332 is insulated and grounded. This is a good arrangement for a number of reasons. First, the arrangement requires only a single polarity voltage supply (e.g., voltage source 340 need only provide a −16KV potential, without requiring any positive supply potential). Thus, system 300 is relatively simple to design, build and manufacture, making it a very cost effective system. Additionally, this arrangement will produce excess negative ions in the airflow, which are known to promote feelings of well being, and are preferable to positive ions. The benefits of the outer mesh electrode 332, as explained above, relate to safety and increased collector efficiency.

Other voltage levels and arrangements are also within the spirit and scope of the present invention. In each arrangement there should be a sufficient potential difference between the emitter electrode(s) 312 and the mesh collector electrode 322 that a sufficient corona region is produced around each emitter electrode 312 to charge particles and cause the particles to accelerate toward the adjacent portions of the mesh collector electrode 322. For example, in another arrangement, the emitter electrode(s) 312 can be connected to a positive output terminal of the high voltage source 340, while the mesh collector electrode 322 is connected to a negative output terminal of the high voltage source 340. In a further arrangement, the emitter electrode(s) 312 can be connected to a negative output terminal of the high voltage source 340, while the mesh collector electrode 322 is connected to a positive output terminal. While this arrangement should produce good airflow and collecting efficiency, it may also produce excess positive ions, which are not as desirable. In still another embodiment, the emitter electrode(s) 312 can be connected to a negative output terminal of the high voltage source 340, while the mesh collector electrode 322 is grounded.

In each of the above described electrode arrangements, it is preferable that the outer mesh electrode 332 be grounded and insulated. However, it is possible to have the outer mesh electrode 332 be at a high voltage, if there is some type of housing that surrounds the outer mesh electrodes and keeps a persons fingers far enough away from the charged outer mesh electrode 332. It is also possible to not have an outer mesh electrode 332 at all, if there is some type of housing that surrounds the outer mesh electrodes and keeps a persons fingers far enough away from the mesh collector electrode 322, although this will likely result in less collecting efficiency. It is also possible to not insulate the outer mesh electrode 332. But as discussed above, if the outer mesh electrode 332 is not insulated, it must be placed a further distance from the mesh collector electrode 322 so as to prevent sparking therebetween.

In the example discussed above, the potential difference between the emitter electrode(s) 312 and the mesh collector electrode 322 was 16KV. This is just an exemplary potential difference. Higher and lower potential differences can also be used.

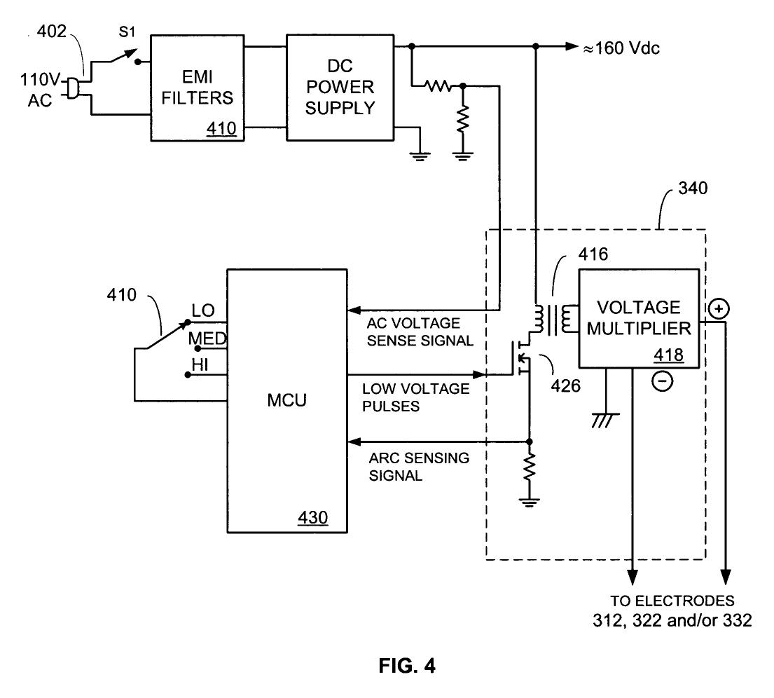

FIG. 4 is an electrical block diagram showing an exemplary implementation of the high voltage source 340 that can be used to power the various embodiments of the present invention discussed above. An electrical power cord 402 that plugs into a common electrical wall socket can be used to accept a nominal 110VAC. An electromagnetic interference (EMI) filter 410 is placed across the incoming nominal 110VAC line to reduce and/or eliminate high frequencies generated by the various circuits. Electrical components such as the EMI Filter are well known in the art and do not require a further description.

A DC Power Supply 414, which is well known, is designed to receive the incoming nominal 110VAC and to output a first DC voltage (e.g., 160VDC). The first DC voltage (e.g., 160VDC) is shown as being stepped down through a resistor network to a second DC voltage (e.g., about 12VDC) that a micro-controller unit (MCU) 430 can monitor without being damaged. The MCU 430 can be, for example, a Motorola 68HC908 series micro-controller, available from Motorola. In accordance with an embodiment of the present invention, the MCU 430 monitors the stepped down voltage (e.g., about 12VDC), which is labeled the AC voltage sense signal in FIG. 4, to determine if the AC line voltage is above or below the nominal 110VAC, and to sense changes in the AC line voltage. For example, if a nominal 110VAC increases by 10% to 121 VAC, then the stepped down DC voltage will also increase by 10%. The MCU 430 can sense this increase and then reduce the pulse width, duty cycle and/or frequency of the low voltage pulses it outputs to maintain the output power of the high voltage source 340 to be the same as when the line voltage is at 110VAC. Conversely, when the line voltage drops, the MCU 430 can sense this decrease and appropriately increase the pulse width, duty cycle and/or frequency of the low voltage pulses to maintain a constant output power. Such voltage adjustment features also enable the same unit to be used in different countries that have different nominal voltages than in the United States (e.g., in Japan the nominal AC voltage is 100VAC).

Output voltage potentials of the high voltage source 340 can be provided to the emitter electrode(s) 312, the mesh collector electrode 322 and/or the insulated outer mesh electrode 332, depending upon which embodiment of the present invention discussed above is being practiced. The high voltage source 340 can be implemented in many ways. In the exemplary embodiment shown, the high voltage source 340 includes an electronic switch 426, a step-up transformer 416 and a voltage multiplier 418. The primary side of the step-up transformer 416 receives the first DC voltage (e.g., 160VDC) from the DC power supply. An electronic switch receives low voltage pulses (of perhaps 20-25 KHz frequency) from the MCU 430. Such a switch is shown as an insulated gate bipolar transistor (IGBT) 426. The IGBT 426, or other appropriate switch, couples the low voltage pulses from the MCU 430 to the input winding of the step-up transformer 416. The secondary winding of the transformer 416 is coupled to the voltage multiplier 418, which outputs high voltage potentials that can be provided to the appropriate electrode(s) 312, 322 and/or 332, based on which embodiment is implemented. In general, the IGBT 426 operates as an electronic on/off switch. Such a transistor is well known in the art and does not require a further description. When driven, the high voltage source 340 receives the low input DC voltage (e.g., 160VDC) from the DC power supply414 and the low voltage pulses from the MCU 430 (with a repetition rate of, for example, about 20 to 25 KHz), and generates a high voltage potential of, for example, 16 KV peak-to-peak. Other peak-to-peak voltages can be used.

These are just a few examples of the various voltages the can be provided for a few of the embodiments discussed above. It is within the scope of the present invention for the voltage multiplier 418 to produce greater or smaller voltages. The high voltage pulses can, for example, have a duty cycle of about 10%-15%, but may have other duty cycles, including a 100% duty cycle.

The MCU 430 can receive an indication of whether the control dial 410 is set to the LOW, MEDIUM or HIGH airflow setting. The MCU 430 controls the pulse width, duty cycle and/or frequency of the low voltage pulse signal provided to switch 426, to thereby control the airflow output, based on the setting of the control dial 410. To increase the airflow output, the MCU 430 can increase the pulse width, frequency and/or duty cycle. Conversely, to decrease the airflow output rate, the MCU 430 can reduce the pulse width, frequency and/or duty cycle. In accordance with an embodiment, the low voltage pulse signal (provided from the MCU 430 to the high voltage source 340) can have a fixed pulse width, frequency and duty cycle for the LOW setting, another fixed pulse width, frequency and duty cycle for the MEDIUM setting, and a further fixed pulse width, frequency and duty cycle for the HIGH setting. However, depending on the setting of the control dial 410, the above described embodiment may produce too much ozone (e.g., at the HIGH setting) or too little airflow output (e.g., at the LOW setting). According, a more elegant solution, described below, can be used.

In accordance with an embodiment, the low voltage pulse signal created by the MCU 430 modulates between a “high” airflow signal and a “low” airflow signal, with the control dial setting specifying the durations of the “high” airflow signal and/or the “low” airflow signal. This will produce an acceptable airflow output, while limiting ozone production to acceptable levels, regardless of whether the control dial 410 is set to HIGH, MEDIUM or LOW. For example, the “high” airflow signal can have a pulse width of 5 microseconds and a period of 40 microseconds (i.e., a 12.5% duty cycle), and the “low” airflow signal can have a pulse width of 4 microseconds and a period of 40 microseconds (i.e., a 10% duty cycle). When the control dial 410 is set to HIGH, the MCU 430 outputs a low voltage pulse signal that modulates between the “low” airflow signal and the “high” airflow signal, with, for example, the “high” airflow signal being output for 2.0 seconds, followed by the “low” airflow signal being output for 8.0 second. When the control dial 410 is set to MEDIUM, the “low” airflow signal can be increased to, for example, 16 seconds (e.g., the low voltage pulse signal will include the “high” airflow signal for 2.0 seconds, followed by the “low” airflow signal for 16 seconds). When the control dial 410 is set to LOW, the “low” airflow signal can be further increased to, for example, 24 seconds (e.g., the low voltage pulse signal will include a “high” airflow signal for 2.0 seconds, followed by the “low” airflow signal for 24 seconds). Alternatively, or additionally, the frequency of the low voltage pulse signal (used to drive the transformer 416) can be adjusted to distinguish between the LOW, MEDIUM and HIGH settings. These are just a few examples of how air flow can be controlled based on a control dial setting.

In practice, an electro-kinetic transporter-conditioner unit is placed in a room and connected to an appropriate source of operating potential, typically 110 VAC. The energized electro-kinetic transporter conditioner emits ionized air and small amounts of ozone. The airflow is indeed electro-kinetically produced, in that there are no intentionally moving parts within unit. (Some mechanical vibration may occur within the electrodes). Additionally, because particles are collected the mesh collector electrode 332, the air in the room is cleaned. It would also be possible, if desired, to further increase airflow by adding one or more fan 380, e.g., as shown in FIG. 3F.

In accordance with an embodiment of the present invention, the voltage of the emitter electrode(s) 312, mesh collector electrode 322 and insulated outer mesh electrode 332 can be independently adjusted. This allows for corona current adjustment (produced by the electric field between the emitter electrode(s) 312 and the mesh collector electrode 322) to be performed independently of the adjustments to the electric fields between the insulated outer mesh electrode 332 and the mesh collector electrode 322. However, this is not necessary in all embodiments of the invention (e.g., in the embodiments where both the emitter electrode(s) 312 and the outer mesh electrode are grounded).

The electric field produced between the emitter electrode(s) 312 and the mesh collector electrode 322 (also referred to as the ionization regions) produce ions and cause air movement in a direction from the emitter electrode(s) 312 toward adjacent portions of the mesh collector electrode 322. The electric field produced between the mesh collector electrode 322 and the outer mesh electrode 332 increase particle capture by pushing charged particles in the air flow back toward the collector electrode 322.

In addition to producing ions, the systems described above will also produce ozone (O₃). While limited amounts of ozone are useful for eliminating odors, concentrations of ozone beyond recommended levels are generally undesirable. In accordance with embodiments of the present invention, ozone production is reduced by coating the outer mesh electrode 332 with an ozone reducing catalyst. Exemplary ozone reducing catalysts include manganese dioxide and activated carbon. Commercially available ozone reducing catalysts such as PremAir™ manufactured by Englehard Corporation of Iselin, N.J., can also be used. Preferably the ozone reducing catalyst is nonconductive so that the catalyst does not defeat the purpose of insulating the outer mesh electrode 332. An example of an insulating ozone reducing catalysts is manganese dioxide.

When using a catalyst that is not electrically conductive, the insulation can be applied in any available manner because the catalyst will act as an additional insulator, and thus not defeat the purpose of adding the insulator. However, if a catalyst that is electrically conductive (e.g., such as activated carbon) is used, it is important that the electrically conductive catalyst does not interfere with the benefits of insulating the outer mesh conductor 332. For example, this can be accomplished by making sure that there is an insulated gap between the electrically conductive catalyst and the wire or other conductor that connects the underlying outer mesh electrode (under the insulation) to a voltage potential (e.g., ground, a positive voltage, or a negative voltage). So long as an electrically conductive ozone reducing catalyst does not touch the wire that connects the underlying outer mesh electrode to a voltage potential, then the potential of the electrically conductive ozone reducing catalysts will remain floating. Other examples of electrically conductive ozone reducing catalysts include, but are not limited to, noble metals.

In accordance with another embodiment of the present invention, if the ozone reducing catalyst is not electrically conductive, then the ozone reducing catalyst can be included in, or used as, the insulation of the outer mesh electrode 332. Preferably the ozone reducing catalysts should have a dielectric strength of at least 1000 V/mil in this embodiment.

The charged particles that travel from the regions near the emitter electrode(s) 312 toward the mesh collector electrode 322 are missing electrons. In order to clean the air, it is desirable that the particles stick to the mesh collector electrode 322 (which can later be cleaned). Accordingly, it is desirable that the exposed surfaces of the collector electrode 322 are electrically conductive so that the mesh collector electrode 322 can give up a charge (i.e., an electron), thereby causing the particles to stick to the mesh collector electrode 322. Accordingly, if an ozone reducing catalyst is electrically conductive, the mesh collector electrode 322 can be coated with the catalyst. However, it is preferably to coat the outer mesh electrode 332 with an ozone reducing catalyst, rather than the mesh collector electrode 322. This is because as particles collect on the mesh collector electrode 322, the physical surfaces of the mesh collector electrode 322 become covered with the particles, thereby reducing the effectiveness of the ozone reducing catalyst. The outer mesh electrode 332, on the other hand, does not collect particles. Thus, the ozone reducing effectiveness of a catalyst coating the outer mesh electrode 332 will not diminish due to being covered by particles.

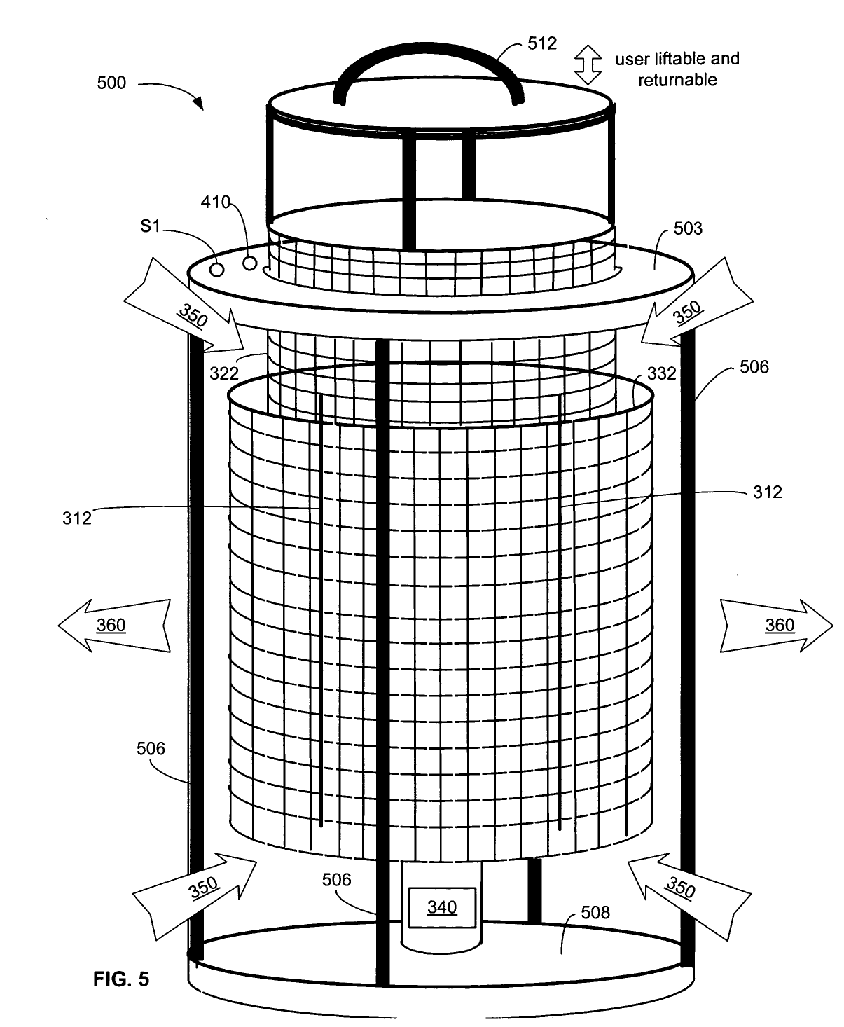

Referring now to FIG. 5, the above described electro-kinetic air transporter-conditioner systems are likely within or include a housing or support frame 500. The housing 500 can include specific input and output vents (not shown), or can have a skeletal appearance, as shown in FIG. 5. The housing or support frame 500 is shown as including a base 508 and a top 503, with support structures 506 therebetween. Such a configuration allows air to easily flow into and out of the mesh electrodes 322 and 332. In accordance with an embodiment of the present invention, the base 508 and top 503 are positioned such that air can enter into the hollow inner portion of the mesh collector electrode 322 through the top and/or bottom of the hollow electrode (as represented by arrows 350). Although this is preferable, it is not necessary. That is, even if the bottom and top of the cylindrical mesh electrodes 322 and 332 were covered, air could still enter the hollow portion of the mesh collector electrode 322 through the mesh walls of electrodes 322 and 332.

The housing 500 is likely free standing and/or upstandingly vertical and/or elongated. The base 508 allows the housing 500 to remain in a vertical position.

Within or supported by the housing 500 is one of the electro-kinetic transporter and conditioner systems described above. The electro-kinetic transporter and conditioner system is likely powered by an AC-DC power supply (e.g., as described above with reference to FIG. 4) that is energizable or excitable using switch S1. Switch S1, along with the other user operated switches such as the control dial 410, are preferably located on or near the top 503 of the housing 500, but can be at other locations, such as on the base 508. The whole system is self-contained in that other than ambient air, nothing is required from beyond the transporter housing 500, except perhaps an external operating voltage, for operation of the present invention.

A user-liftable handle member 512 is preferably affixed the mesh collector electrode 322, which normally rests within the housing 500. In the embodiment shown, the handle member 512 can be used to lift the mesh collector electrode 322 upward causing the mesh collector electrode 322 to telescope out of the top of the housing 500 for cleaning, while the emitter electrode(s) 312 and insulated outer mesh electrode 332 remain within the housing 500. As is evident from FIG. 5, the mesh collector electrode 322 can be lifted vertically out through an opening in the top 503 of the housing along the longitudinal axis or direction of the elongated housing 500. This arrangement with the collector electrode 322 removable through atop portion of the housing 500, makes it easy for a user to pull the collector electrode 322 out for cleaning, and to return the collector electrode 322, with the assistance of gravity, back to their resting position within the housing 500. If desired, the emitter electrode(s) 312 and/or the outer mesh electrode 332 may be made similarly removable.

If the emitter electrode(s) 312 are not removable, then a free-floating slidable member (e.g., a bead or some other member) having a through opening, through which an electrode passes, can be used to clean the emitter electrodes. Such a slidable member could be slid along the emitter electrode(s) (e.g., by rotating the device housing) to frictionally clean the emitter electrode(s). Alternatively, a wiper or scraper (e.g., a strip or sheet of flexible insulating material) can be connected with the collector electrode 322 and extend toward the emitter electrode(s) 312, such that the emitter electrode(s) are cleaned when the collector 322 is removed out the top of the device housing. Further details relating to cleaning emitter electrodes are described in U.S. Pat. No. 6,350,417, entitled “Electrode Self-Cleaning Mechanism for Electro-Kinetic Air Transporter Conditioner Devices,” which is incorporated herein by reference.

In each of the embodiments where one or more electrode is removable, there is likely one or more contact terminals within the housing 500 that will provide a conductive path from a terminal of the high voltage source 340 to an appropriate electrode, when that electrode is in its resting position within the housing 500. When the electrode (e.g., mesh collector electrode 322) is lifted (e.g., using the user-liftable handle 512), the electrode and the contact terminal will disengage from one another. This will ensure that an electrode(s) lifted from the housing 500 is no longer providing a high voltage potential. If the removable electrode is intended to be grounded in accordance with an embodiment of the present invention, the corresponding contact terminal within the housing 500 for that electrode should be grounded.

The foregoing descriptions of the preferred embodiments of the present invention have been provided for the purposes of illustration and description. It is not intended to be exhaustive or to limit the invention to the precise forms disclosed. Many modifications and variations will be apparent to the practitioner skilled in the art. Modifications and variations may be made to the disclosed embodiments without departing from the subject and spirit of the invention as defined by the following claims. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

1. An electro-kinetic air conditioner device, comprising:
an inner hollow cylindrical mesh collector electrode having a first radius;
a grounded outer hollow cylindrical mesh electrode having a second radius that is larger than said first radius, said outer hollow cylindrical mesh electrode surrounding said inner hollow cylindrical mesh electrode;
at least one emitter electrode within and generally parallel to said inner hollow cylindrical collector electrode; and
a voltage source to provide a high voltage potential difference between each said emitter electrode and said inner hollow cylindrical mesh electrode;
wherein a flow of air including ions and charged particles is produced from each said emitter electrode toward an adjacent portion of said hollow mesh collector electrode; and
wherein at least a portion of the charged particles are attracted to and collect on said inner hollow mesh collector electrode, thereby cleaning the air.

2. The device of claim 1, wherein:
said voltage source provides a high negative voltage to said inner hollow cylindrical mesh collector electrode; and
each said emitter electrode is grounded.

3. The device of claim 1, wherein each said emitter electrode comprises a wire-shaped electrode.

4. The device of claim 1, wherein each said emitter electrode is located closer to a circumference of said inner hollow cylindrical mesh collector electrode than to a radial center of said inner hollow cylindrical mesh collector electrode.

5. The device of claim 1, wherein said outer hollow cylindrical mesh electrode includes an electrically conductive mesh covered by an insulating dielectric material.

6. The device of claim 5, wherein said dielectric material is coated with an ozone reducing catalyst.

7. The device of claim 1, wherein said outer hollow cylindrical mesh electrode is coated with an ozone reducing catalyst.

8. An electro-kinetic air conditioner device, comprising:
an inner hollow mesh electrode;
an outer hollow mesh electrode surrounding said inner hollow mesh electrode;
at least one emitter electrode within said inner hollow mesh electrode; and
a voltage source to provide a high voltage potential difference between. each said emitter electrode and said inner hollow mesh electrode.

9. The device of claim 8, wherein said outer hollow mesh electrode is grounded.

10. The device of claim 9, wherein each said emitter electrode is generally parallel to said inner hollow mesh electrode.

11. The device of claim 10, wherein each said emitter electrode is closer to a mesh wall of said inner hollow mesh electrode than to a radial center of said inner hollow mesh electrode.

12. The device of claim 10, comprising at least two said emitter electrodes, and wherein each said emitter electrode is generally arranged equianglarly about said inner hollow mesh electrode such that ionization regions formed about emitter electrodes do not interfere with one another.

13. The device of claim 8, wherein:
said voltage source provides a high negative voltage to said inner hollow mesh electrode; and
each said emitter electrode is grounded.

14. The device of claim 8, wherein each said emitter electrode comprises a wire-shaped electrode.

15. The device of claim 8, wherein said outer hollow mesh electrode includes an electrically conductive mesh covered by an insulating dielectric material.

16. The device of claim 15, wherein said dielectric material is coated with an ozone reducing catalyst.

17. The device of claim 8, wherein said outer hollow mesh electrode is coated with an ozone reducing catalyst.

18. An electro-kinetic air conditioner device, comprising:
a hollow mesh collector electrode;
at least one emitter electrode within said hollow mesh collector electrode; and
a voltage source to provide a high voltage potential difference between each said emitter electrode and said hollow mesh collector electrode.

19. The device of claim 18, wherein each said emitter electrode is generally parallel to said hollow mesh collector electrode.

20. The device of claim 19, further comprising an outer hollow mesh electrode surrounding said hollow mesh collector electrode

21. The device of claim 20, wherein said outer hollow mesh electrode is insulated and grounded.

22. The device of claim 18, wherein:
a flow of air including ions and charged particles is produced from each said emitter electrode toward an adjacent mesh wall of said hollow mesh collector electrode, and at least a portion of the charged particles are attracted to and collect on said hollow mesh collector electrode, thereby cleaning the air.

23. An electro-kinetic air conditioner device, comprising:
an inner hollow cylindrical collector electrode, that allows air to pass therethrough, having a first radius,
a grounded outer hollow cylindrical electrode, that allows air to pass therethrough, having a second radius that is larger than said first radius, said outer hollow cylindrical electrode surrounding inner hollow cylindrical electrode;
at least one emitter electrode within said inner hollow cylindrical collector electrode; and
a voltage source to provide a high voltage potential to said inner hollow cylindrical electrode; and
wherein a flow of air is produced from each said emitter electrode toward an adjacent portion of said hollow collector electrode.

24. An electro-kinetic air conditioner device, comprising:
an inner hollow electrode that allows air to pass therethrough;
at least one emitter electrode within said inner hollow electrode; and
a voltage source to provide a high voltage potential to said inner hollow electrode.

25. The device of claim 24, wherein each said emitter is grounded.

26. The device of claim 24, further comprising an outer hollow electrode that allows air to pass therethrough, surrounding said inner hollow electrode.

27. The device of claim 26, wherein each said emitter and said outer hollow electrode are grounded.

28. An electro-kinetic air conditioner device, comprising:
a housing;
a inner hollow mesh collector electrode supported by said housing;
a grounded and insulated outer hollow mesh electrode, surrounding said hollow mesh electrode, also supported by said housing;
at least two emitter electrodes each within and generally parallel to said first inner hollow mesh electrode; and
a voltage source;
wherein said inner hollow mesh collector electrode is removable for cleaning from a resting position supported by said housing to a location outside said housing; and
wherein said high voltage source provides a high voltage potential difference, between said emitter electrodes and said inner hollow mesh collector electrode, when said inner hollow mesh electrode is in the resting position.

29. The device of claim 28, wherein said housing includes a top having an opening, and wherein said inner hollow cylindrical mesh collecting electrode is removable through said opening.

30. The device of claim 29, further comprising a handle attached to said inner hollow cylindrical mesh collector electrode to assist with removal of said inner hollow cylindrical mesh collector electrode.

31. The device of claim 28, further comprising a handle to assist with removal of said inner hollow cylindrical mesh collector electrode.

32. A method for providing an electro-kinetic air transporter-conditioner system, comprising:
providing an inner hollow cylindrical mesh collector electrode having a first radius;
providing an outer hollow cylindrical mesh electrode having a second radius that is larger than said first radius, said outer hollow cylindrical mesh electrode surrounding said inner hollow cylindrical mesh collector electrode;
providing at least one emitter electrode within and generally parallel to said inner hollow cylindrical mesh collector electrode;
providing a high voltage potential difference between each said emitter electrode and said inner hollow cylindrical mesh electrode; and
grounding said outer hollow cylindrical mesh electrode.

33. A method for providing an electro-kinetic air transporter-conditioner system, comprising:
providing an inner hollow mesh collector electrode;
providing an outer hollow mesh electrode surrounding said inner hollow mesh collector electrode,
providing at least one emitter electrode within and generally parallel to said inner hollow mesh collector electrode;
providing a high voltage potential difference between each said emitter electrode and said inner hollow mesh collector electrode; and
grounding said outer hollow cylindrical mesh electrode.
